(19) United States
(12) Patent Application Publication
(10) Pub. No.: US 2016/0015072 A1
(43) Pub. Date: Jan. 21, 2016

(54) Nutritional Composition

(71) Applicants: Rosa M. Calderon, Las Vegas, NV (US); Byron Fant, Las Vegas, NV (US)

(72) Inventors: Rosa M. Calderon, Las Vegas, NV (US); Byron Fant, Las Vegas, NV (US)

(21) Appl. No.: 14/602,702

(22) Filed: Jan. 22, 2015

Related U.S. Application Data
(60) Provisional application No. 61/999,174, filed on Jul. 21, 2014.

(51) Int. Cl. A23L 2/04

(52) U.S. Cl. CPC A23L 2/04; A23V 2002/00

(57) ABSTRACT

A nutritional composition comprises at least one organic vegetable, at least one organic fruit, and at least one organic root that are mixed, strained, and blended, and have no other ingredients. The composition may include an organic drink with specific health benefits and tasteful characteristics. Each ingredient comprises a unique vitamin or mineral. In one embodiment, the composition consists of celery, beets, red Swiss chard with the leaves, and Granny Smith apples. These ingredients may be finely blended, strained, and bottled for consumption. The composition, may be substantially free of sugar, preservatives, artificial coloring, and cooked odor attributable to heat sterilization treatment. A blending device blends the ingredients. A filtering device filters a liquid portion for a pulp portion. A container contains the liquid portion from a portion of the pulp portion. The composition is consumed from the container.

### CROSS-REFERENCE TO RELATED APPLICATIONS

The present Utility patent application claims priority benefit of the [U.S. provisional application for patent Ser. No. 61/999,174, filed on Jul. 21, 2014, under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a nutritional composition. More particularly, the invention relates to a nutritional composition and a method of making the nutritional composition comprising at least one organic vegetable, at least one organic fruit, and at least one root that are mixed, strained, and blended, and have no other ingredients.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that it is healthful to consume a prescribed recommended daily intake of certain vitamins and minerals as part of an individual's diet. It is well recognized that numerous recommended nutrients can be obtained through the consumption of fruits and vegetables.

Typically, in order to supply the body with these required nutrients, in addition to the raw-food and cooked consumption of fruits and vegetables, various mediums are available for the public consumption of these fruits and vegetables. Each of these processing methods exhibits certain traits and abilities to maintain the nutritive value of the base fruit and vegetable.

In many instances, fruit juice, vegetable juice, or blended fruit and vegetable juices are a popular food medium for supplying the recommended vitamins and minerals. The extraction of liquid to create juices from food products, such as fruits and vegetables, typically yields fibrous pulp or pulp byproduct. Mechanical liquid extraction devices, such as blenders and strainers can be used to extract the maximum liquid.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a perspective view of exemplary vegetable, fruit, and root used to make an exemplary nutritional composition, in accordance with an embodiment of the present invention;

FIGS. 2A, 2B, and 2C illustrate perspective views of exemplary vegetable, fruit, and root being placed into an exemplary blending device, where FIG. 2A illustrates an exemplary celery and apple being placed into the blending device, FIG. 2B illustrates an exemplary beet being placed into the blending device, and FIG. 2C illustrates an exemplary red Swiss chard with leaves being placed into the blending device, in accordance with an embodiment of the present invention;

FIG. 3 illustrates a perspective view of an exemplary blending device at least partially blending the ingredients, in accordance with an embodiment of the present invention;

FIG. 4 illustrates a perspective view of an exemplary filtering device at least partially straining a liquid portion form a pulp portion of the blended composition, in accordance with an embodiment of the present invention; and

FIGS. 5A and 5B illustrate perspective views of an exemplary container configured to contain the composition, where FIG. 5A illustrates the composition inside the container, and FIG. 5B illustrates the composition being consumed, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of nutritional drinks with fruits and vegetables that may be provided by preferred embodiments of the present invention. In one embodiment of the present invention, a nutritional composition comprises at least one organic vegetable, at least one organic fruit, and at least one organic root that are mixed, strained, and blended, and have no other ingredients. The composition may include an organic drink with specific health benefits and tasteful characteristics. In one embodiment, the composition consists of celery, beets, red Swiss chard (with the leaves) and Granny Smith apples. These ingredients may be finely blended, strained, and bottled for consumption. The composition, may be substantially free of sugar, preservatives, artificial coloring, and cooked odor attributable to heat sterilization treatment.

However, the composition still retains a desirable taste and a puree feeling while being swallowed. The sweetness provided by the apple, and a specific Granny Smith apple, along with the unique blending and straining techniques applied thereto create a unique taste and texture. In this manner, the composition provides an excellent in taste and feeling as it passes down the throat when swallowed. The composition may require refrigeration, and is possible to consume over a long period of time.

The composition may meet or near dietary reference intake (RDA) recommendations for many vitamins, minerals and nutrients. The at least one fruit, the at least one vegetable, and the at least one root may be organic, and offer specific nutritional content that offers specific health benefits. Each vegetable, fruit, and root in the composition contributes its unique vitamin and minerals to create a nutritional synergy throughout the composition.

For example, without limitation, the composition contains an above-average content of at least one of the following: Vitamins A, K, E, B2, C, magnesium, copper, manganese, potassium, iron, calcium, choline, chlorophyll, folic acid, beta carotene, betaine and riboflavin. Additionally, the composition may provide a high content of betalin, pectin, boron, and antioxidants. These vitamins and minerals are efficacious for providing nutrition to the body and cleansing organs in the body.

The preparation of the composition may be relatively easy. The at least one vegetable, fruit, and root are required to be organic. The vegetable, fruit, and root are washed and laid out for cutting. The vegetable, fruit, and root may be cut up into approximate ½-1″ chunks for mixing in a blending device. After cutting the vegetable, fruit, and root are placed inside the blending device and mixed. The blending device may mix, puree, or emulsify the ingredients, as the used desires the texture.

After the ingredients have been mixed into a liquid paste of desirable viscosity, the composition may include a small portion of pulp, and a larger portion of liquid. The blended composition may then be strained in a standard strainer to remove most of the pulp and enable passage of the liquid juice portion of the composition. It is this liquid and small portion of pulp that passes through the strainer that is consumed. The consumable composition may then be poured into a container, such as a bottle. Since no preservatives are added, the composition should be consumed soon thereafter, or refrigerated.

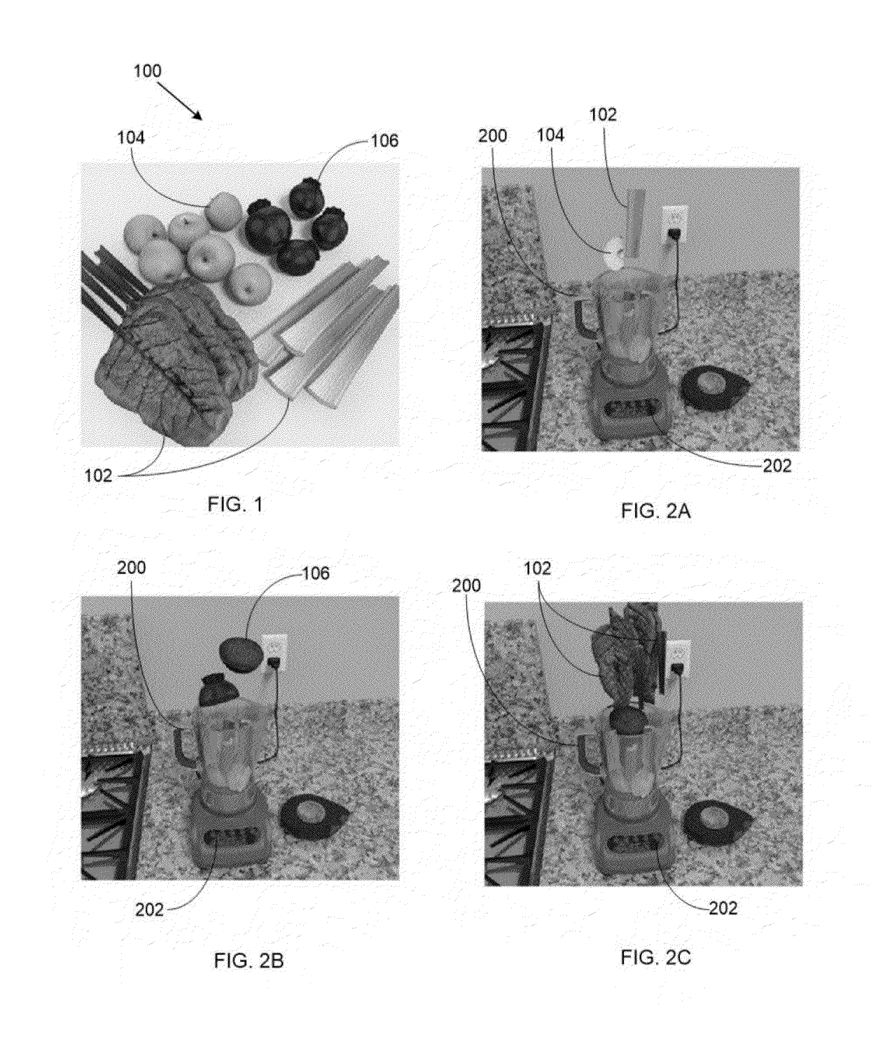

FIG. 1 illustrates a perspective view of exemplary vegetable, fruit, and root used to make an exemplary nutritional composition, in accordance with an embodiment of the present invention. In one aspect, a nutritional composition 100 comprises at least one organic vegetable 102, at least one organic fruit 104, and at least one organic root 104 that are mixed, strained, and blended. In some embodiments, the vegetable, fruit, and root may form the only ingredients in the composition, such that no sugar, preservatives, or coloring is added.

The composition may include an organic drink with specific health benefits and tasteful characteristics. In one embodiment, the composition consists of a celery, a red Swiss chard with the leaves, a Granny Smith apples, and a beet. These ingredients may be finely blended, strained, and bottled for consumption. The blending process may separate the composition into a liquid portion and a pulp portion. The composition, may be substantially free of sugar, preservatives, artificial coloring, and cooked odor attributable to heat sterilization treatment Different Beets varieties include but are not limited to Table Beets such as Bull's Head, Crosby's Egyptian, Detroit Dark Red, Early Wonder, Sangria, Sweetheart, and Ruby Queen. Also Hybrid Beets such as but not limited to Avenger, Big Red, Gladiator and Red Ace. Also, Miniature Beets such as Little Ball and Little Mini Ball. Specialty Beets can be used to include Clindria, Touchstone Gold, Golden and Di Chioggia. A variety of Apple types can be used to include but not limited to Granny Smith, Sonya, Cameo, Ginger gold, Fuji, McIntosh, Empire, Crispin, Gala, Honey Crisp, Red Delicious, Golden Delicious and Jonagold. A variety of Chards can be used to include but not limited to Monstruoso, Rhubarb, Fordhook Giant, Bright Yellow and Silverado.

However, the composition still retains a desirable taste and a puree feeling while being swallowed. The sweetness provided by the apple, and a specific Granny Smith apple, along with the unique blending and straining techniques applied thereto create a unique taste and texture. In this manner, the composition provides an excellent in taste and feeling as it passes down the throat when swallowed. The composition may require refrigeration, and is possible to consume over a long period of time.

FIGS. 2A, 2B, and 2C illustrate perspective views of exemplary vegetable, fruit, and root being placed into an exemplary blending device, where FIG. 2A illustrates an exemplary celery and apple being placed into the blending device, FIG. 2B illustrates an exemplary beet being placed into the blending device, and FIG. 2C illustrates an exemplary red Swiss chard with leaves being placed into the blending device, in accordance with an embodiment of the present invention. In one aspect, a blending device 200 may be used to blend or mix the ingredients into the composition. The vegetable, fruit, and root may be blended to a desired consistency by varying the speed and blades on the blender.

In some embodiments, a control portion 202 may operatively connect to the blending device. The control portion may selectively power on and off the blending device, and enable selection of mixing, pureeing, or emulsifying the ingredients. In one embodiment, the temperature of the ingredients remains at room temperature while blending. However, in other embodiments, the ingredients may be cooled before blending to achieve a cold composition for enhanced flavor during consumption.

The composition may meet or near dietary reference intake (RDA) recommendations for many vitamins, minerals and nutrients. The at least one fruit, the at least one vegetable, and the at least one root may be organic, and offer specific nutritional content that offers specific health benefits. Each vegetable, fruit, and root in the composition contributes its unique vitamin and minerals to create a nutritional synergy throughout the composition. The composition may be efficacious for cleansing the body through functions of diuretic and laxative. Additional benefits may include, without limitation, an anti-rheumatic, antioxidant, detoxificant, and liver stimulant.

The vegetable comprises at least one unique vegetable vitamin and/or mineral. The vegetable vitamin or mineral may include, without limitation, Vitamin A, Vitamin K, Vitamin E, magnesium, copper, iron, and potassium. However, it is known in the art that celery and red Swiss chard with the leaf have additional vitamins, minerals, and other health benefits.

In another example, the fruit comprises at least one unique fruit vitamin and/or mineral. The fruit vitamin or mineral may include, without limitation, an anti-oxidant, Vitamin C, and beta-carotene. However, it is known in the art that Granny Smith apples have additional vitamins, minerals, and other health benefits. In yet another example, the root comprises at least one unique root vitamin and/or mineral. The root vitamin or mineral may include, without limitation, betalain, folate, and manganese. However, it is known in the art that beets have additional vitamins, minerals, and other health benefits.

In some embodiments, the composition may include an above-average content of at least one of the following: Vitamins A, K, E, B2, C, magnesium, copper, manganese, potassium, iron, calcium, choline, chlorophyll, folic acid, beta carotene, betaine, niacinriboflavin, thiamin and all B vitamins. Additionally, the composition may provide a high content of betalin, pectin, boron, and antioxidants. These vitamins and minerals are efficacious for providing nutrition to the body and cleansing the liver, kidneys and gallbladder. Yet another benefit of drinking the composition may include eliminating carcinogens and lowering blood pressure and cholesterol. In his manner, consumption of the composition protects consumes from cardiovascular diseases, colon and prostate cancer, iron deficiency, and osteoporosis.

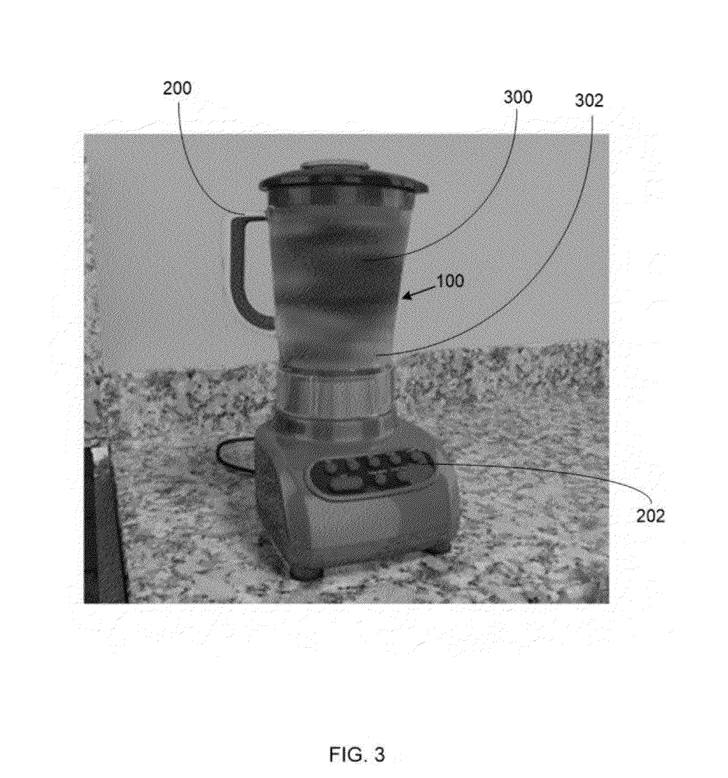

FIG. 3 illustrates a perspective view of an exemplary blending device at least partially blending the ingredients, in accordance with an embodiment of the present invention. In one aspect, a blending device may be used to blend or mix the ingredients into the composition. The blending device may include, without limitation, a blender, a mixer, and a kitchen and laboratory appliance used to mix, puree, or emulsify food and other substances. The vegetable, fruit, and root may be blended to a desired consistency by varying the speed and blades on the blending device.

A control portion may selectively power on and off the blender, and enable selection of mixing, pureeing, or emulsifying the ingredients. In some embodiments, a heating option on the control portion may also be available. After being blended, the composition may at least partially separate into a liquid portion 300 and a pulp portion 302. In some embodiments, the liquid portion may be in greater quantity than the pulp portion.

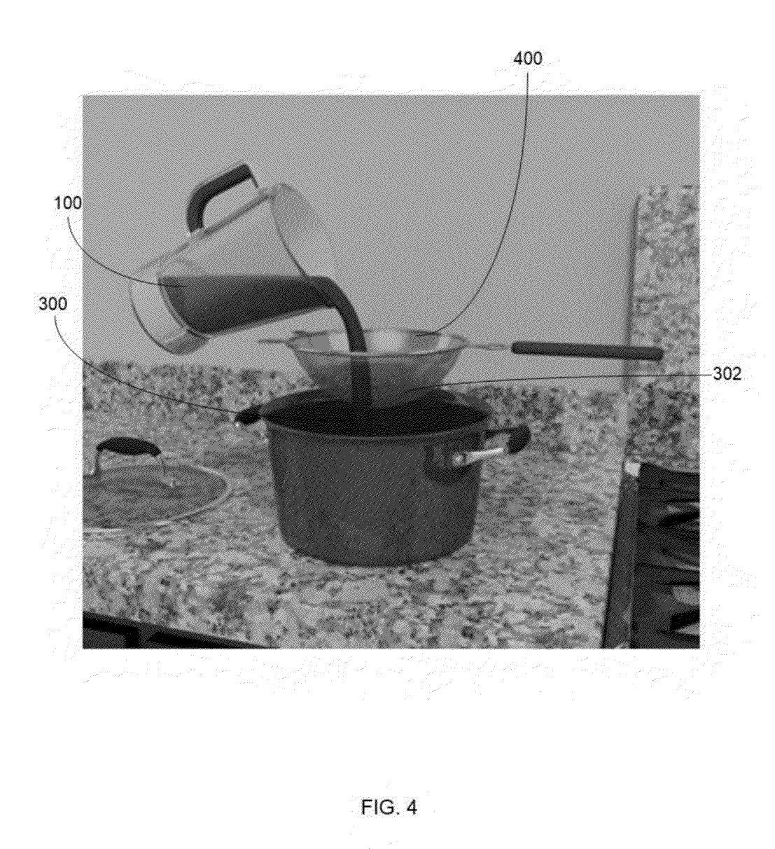

FIG. 4 illustrates a perspective view of an exemplary filtering device at least partially straining a liquid portion form a pulp portion of the blended composition, in accordance with an embodiment of the present invention. In one aspect, the preparation of the composition may be relatively easy. Initially, the at least one vegetable, fruit, and root may be required to be organic. The vegetable, fruit, and root are washed and laid out for cutting. The vegetable, fruit, and root may be cut up into approximate ½-1″ chunks for mixing in a blending device. After cutting the vegetable, fruit, and root are placed inside the blending device and mixed. The blending device may mix, puree, or emulsify the ingredients, as the user desires the texture. Consistencies include very thin smooth liquid all the way to a thick milk shake like.

After the ingredients have been mixed into a liquid paste of desirable viscosity, the composition may include a small portion of pulp, and a larger portion of liquid. The blended composition may then be strained in a filtering device 400, such as a standard strainer to filter out most of the pulp and enable passage of the liquid portion of the composition. It is this liquid portion and small portion of the pulp portion that passes through the strainer that is consumed. Various amounts of pulp can be passed through the strainer. The beverage can contain no pulp, low pulp, medium pulp and high pulp varieties.

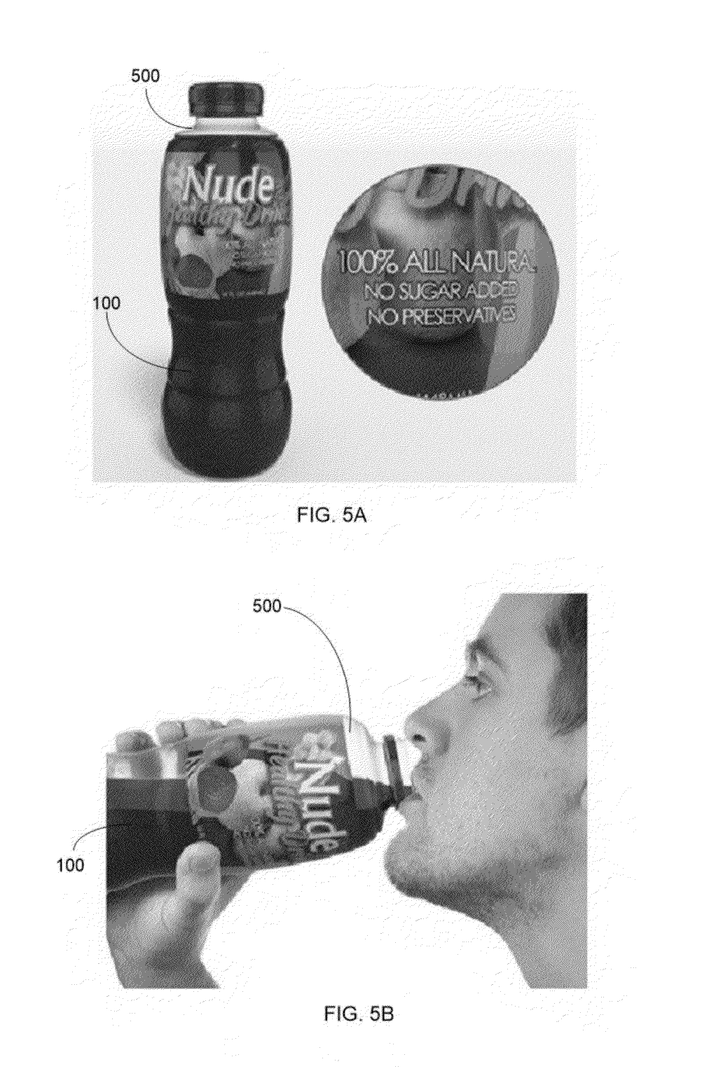

FIGS. 5A and 5B illustrate perspective views of an exemplary container configured to contain the composition, where FIG. 5A illustrates the composition inside the container, and FIG. 5B illustrates the composition being consumed, in accordance with an embodiment of the present invention. In one aspect, the liquid portion and small portion of the pulp portion may be poured into a container 500, such as a bottle for consumption. Since no preservatives are added, the composition may be consumed soon thereafter, or refrigerated. The container may further include, without limitation, a carton box, a hermetically sealed pouch, and a glass.

In one alternative embodiment, the composition may be solidified into a cake by baking the pureed version. In another alternative embodiment, the beet may include any variety of beet roots. In yet another alternative embodiment, the fruit may include a Fuji apple or a Gala apple.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a fruit and vegetable nutritional drink according to the present invention will be apparent to those skilled in the art. Various aspects of the invention have been described above by way of illustration, and the specific embodiments disclosed are not intended to limit the invention to the particular forms disclosed. The particular implementation of the fruit and vegetable nutritional drink may vary depending upon the particular context or application. By way of example, and not limitation, the fruit and vegetable nutritional drink described in the foregoing were principally directed to a nutritional drink made up of celery, beets, red Swiss chard with the leaves included, and apples; however, similar techniques may instead be applied to tints in a vehicle window that can be extended and retracted, depending on the desired look for the vehicle, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A composition comprising:
at least one organic vegetable, said at least one organic vegetable comprising a leaf portion, said at least one organic vegetable further comprising at least one unique vegetable vitamin and/or mineral;
at least one organic fruit, said at least one organic fruit comprising at least one unique fruit vitamin and/or mineral;
at least one organic root, said at least one organic root comprising at least one unique root vitamin and/or mineral;
wherein said at least one organic vegetable, said at least one organic fruit, and said at least one organic root are configured to be at least partially mixed with a blending device for producing said composition;
wherein said composition is configured to be at least partially filtered with a filtering device for extracting a liquid portion and a pulp portion from said blended composition; and
wherein said liquid portion and a portion of said pulp portion are configured to be stored in a container for storage and consumption.

2. The composition of claim 1, in which said composition comprises a nutritional drink.

3. The composition of claim 2, in which said at least one organic vegetable comprises a celery.

4. The composition of claim 3, in which said at least one organic vegetable comprises a red Swiss chard.

5. The composition of claim 4, in which said red Swiss chard comprises said leaf portion.

6. The composition of claim 5, in which said at least one unique vegetable vitamin and/or mineral comprises at least one member from the group consisting of: Vitamin A, Vitamin K, Vitamin E, magnesium, copper, iron, and potassium.

7. The composition of claim 6, in which said at least one organic fruit comprises a Granny Smith Apple.

8. The composition of claim 7, in which said Granny Smith Apple comprises a natural sweetener for enhancing the flavor of said composition.

9. The composition of claim 8, in which said at least one unique fruit vitamin and/or mineral comprises at least one member from the group consisting of: an anti-oxidant, Vitamin C, and beta-carotene.

10. The composition of claim 9, in which said at least one organic root comprises a beet.

11. The composition of claim 10, in which said at least one unique root vitamin and/or mineral comprises at least one member from the group consisting of: betalain, folate, and manganese.

12. The composition of claim 11, in which said blending device comprises an electrical blender.

13. The composition of claim 12, in which said blending device comprises a control portion.

14. The composition of claim 13, wherein said control portion is configured to selectively mix, puree, or emulsify said composition.

15. The composition of claim 14, in which said filtering device comprises a strainer.

16. The composition of claim 15, wherein said strainer is configured to at least partially filter said pulp portion out of said liquid portion.

17. The composition of claim 16, in which said liquid portion is in greater quantity than said pulp portion.

18. The composition of claim 17, in which said container comprises a bottle.

19. A composition comprising:
means for combining a plurality of nutritional means;
means for blending said plurality of nutritional means;
means for filtering said plurality of nutritional means, said filtering means configured to extract a liquid means and a pulp means;
means for containing said liquid means and at least a portion of said pulp means; and
means for consuming at least one unique vitamin and/or mineral from said liquid means and at least a portion of said pulp means.

20. The composition consisting of:
at least one organic vegetable, said at least one organic vegetable comprising a celery, said at least one organic vegetable further comprising a red Swiss chard, said red Swiss chard comprising a leaf portion, said at least one organic vegetable further comprising at least one unique vegetable vitamin and/or mineral, said at least one unique vegetable vitamin and/or mineral comprising at least one member from the group consisting of: Vitamin A, Vitamin K, Vitamin E, magnesium, copper, iron, and potassium;
at least one organic fruit, said at least one organic fruit comprising a Granny Smith apple, said at least one organic fruit further comprising at least one unique fruit vitamin and/or mineral, said at least one unique fruit vitamin and/or mineral comprising at least one member from the group consisting of: an anti-oxidant, Vitamin C, and beta-carotene;
at least one organic root, said at least one organic root comprising a beet, said at least one organic root further comprising at least one unique root vitamin and/or mineral, said at least one unique root vitamin and/or mineral comprising at least one member from the group consisting of: betalain, folate, and manganese;
wherein said at least one organic vegetable, said at least one organic fruit, and said at least one organic root are configured to be at least partially mixed with a blending device, said blending device comprising a control portion, said control portion configured to selectively mix, puree, or emulsify said composition;
wherein said composition is configured to be at least partially filtered with a filtering device for extracting a liquid portion and a pulp portion from said blended composition, said filtering device comprising a strainer; and
wherein said liquid portion and a portion of said pulp portion are configured to be stored in a container for storage and consumption, said container comprising a bottle.
